(19) United States
(12) Patent Application Publication
(10) Pub. No.: US 2026/0302707 A1
(43) Pub. Date: Oct. 1, 2026

(54) TRANSMISSION MECHANISM, ELECTRIC DRIVE DEVICE AND TERMINAL CRIMPING DEVICE

(71) Applicants: Tyco Electronics (Shanghai) Co., Ltd., Shanghai (CN); Tyco Electronics Technology (SIP) Co., Ltd., Suzhou (CN)

(72) Inventors: Shen Zhang, Shanghai (CN); Zhao Ding, Suzhou (CN); Mingming Zhang, Suzhou (CN); Win Wu, Suzhou (CN)

(73) Assignees: Tyco Electronics (Shanghai) Co., Ltd., Shanghai (CN); Tyco Electronics Technology (SIP) Co., Ltd., Suzhou (CN)

(21) Appl. No.: 19/629,021

(22) Filed: Mar. 26, 2026

(30) Foreign Application Priority Data
Mar. 28, 2025 (CN) 202510389837.8

(51) Int. Cl. H01R 43/048; F16H 25/14

(52) U.S. Cl. CPC H01R 43/048; F16H 25/14

(57) ABSTRACT

A transmission mechanism includes an outer sleeve and an eccentric wheel. The outer sleeve is fixed to a movable block. The eccentric wheel is rotatably installed in the outer sleeve. The eccentric wheel is rotatable relative to the outer sleeve. The eccentric wheel has a mounting hole mountable on a drive shaft. A central axis of the mounting hole is parallel to, and at a predetermined distance from, a central axis of the eccentric wheel, such that the transmission mechanism can convert a rotational motion of the drive shaft into a linear reciprocating motion of the movable block.

### CROSS-REFERENCE TO RELATED APPLICATION

This application claims the benefit of the filing date under 35 U.S.C. § 119(a)-(d) of Chinese Patent Application No. CN 202510389837.8 filed on Mar. 28, 2025, the whole disclosure of which is incorporated herein by reference.

### FIELD OF THE INVENTION

The present invention relates to a transmission mechanism and, more particularly, to a transmission mechanism, an electric drive device comprising the transmission mechanism, and a terminal crimping device comprising the electric drive device.

### BACKGROUND OF THE INVENTION

A terminal crimping device typically includes a fixed block, a movable block mounted in the guide groove of the fixed block, a crimping block mounted at the bottom of the movable block, and a cylinder mounted on the fixed block. The piston rod of the cylinder is connected to the movable block, which is used to drive the movable block to move along the guide groove. The movable block is used to drive the crimping block to move vertically, in order to crimp the terminal onto a flexible flat cable or flexible circuit board. The crimping block is used to clamp and crimp the terminal, keeping it in the correct crimping position to ensure a good crimping result. However, the slow response of the cylinder results in a slow crimping speed of the terminal crimping device, which seriously restricts the efficiency of terminal crimping. In addition, the cylinder drive device also has the disadvantages of large volume and high cost.

### SUMMARY OF THE INVENTION

A transmission mechanism includes an outer sleeve and an eccentric wheel. The outer sleeve is fixed to a movable block. The eccentric wheel is rotatably installed in the outer sleeve. The eccentric wheel is rotatable relative to the outer sleeve. The eccentric wheel has a mounting hole mountable on a drive shaft. A central axis of the mounting hole is parallel to, and at a predetermined distance from, a central axis of the eccentric wheel, such that the transmission mechanism can convert a rotational motion of the drive shaft into a linear reciprocating motion of the movable block.

### BRIEF DESCRIPTION OF DRAWINGS

The invention will now be described by way of example with reference to the accompanying figures, of which:

FIG. 1 is a perspective view of a transmission mechanism according to an exemplary embodiment;

FIG. 2 is an exploded view of the transmission mechanism of FIG. 1;

FIG. 3 is a perspective view of a cylindrical cage and rollers of the transmission mechanism of FIG. 1;

FIG. 4 is a sectional view of the transmission mechanism of FIG. 1;

FIG. 5 is an exploded sectional view of the transmission mechanism of FIG. 1;

FIG. 6 is an exploded view of an electric drive device according to an exemplary embodiment;

FIG. 7 is a perspective assembled view of the electric drive device of FIG. 6;

FIG. 8 is a perspective assembly view of a movable block, a crimping block, an elastic component, and the transmission mechanism of FIG. 1 of a terminal crimping device according to an exemplary embodiment;

FIG. 9 is an exploded view of the terminal crimping device of FIG. 8;

FIG. 10 is a perspective assembly view of the terminal crimping device of FIG. 8; and

FIG. 11 is a cross-sectional view of the terminal crimping device of FIG. 8.

### DETAILED DESCRIPTION

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

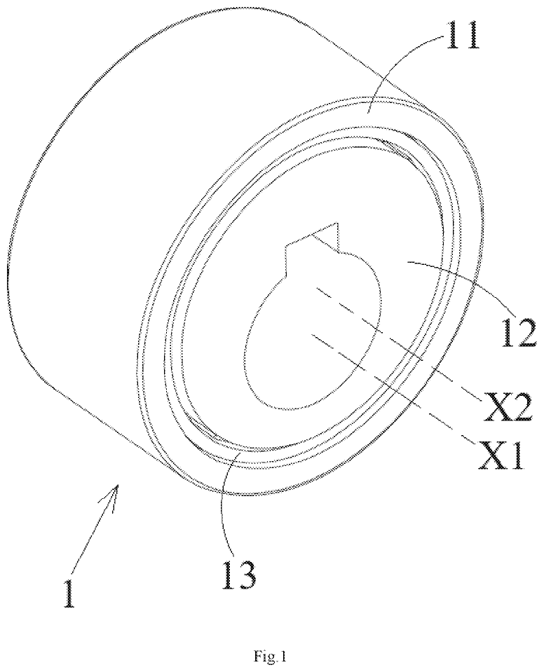

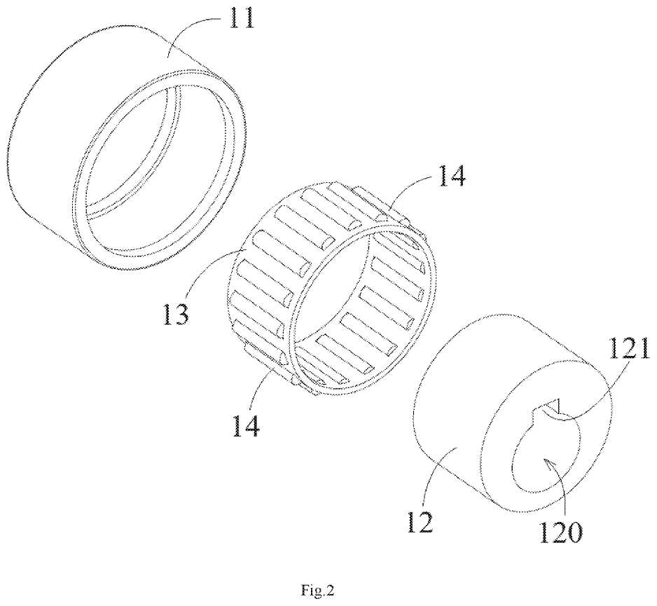

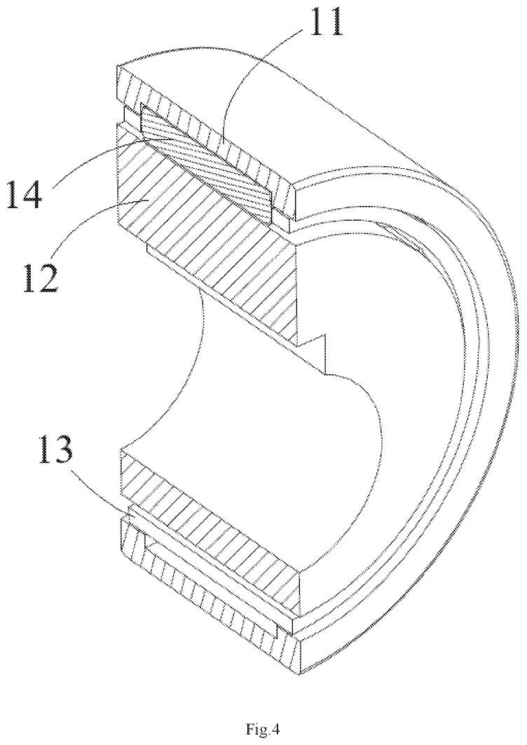

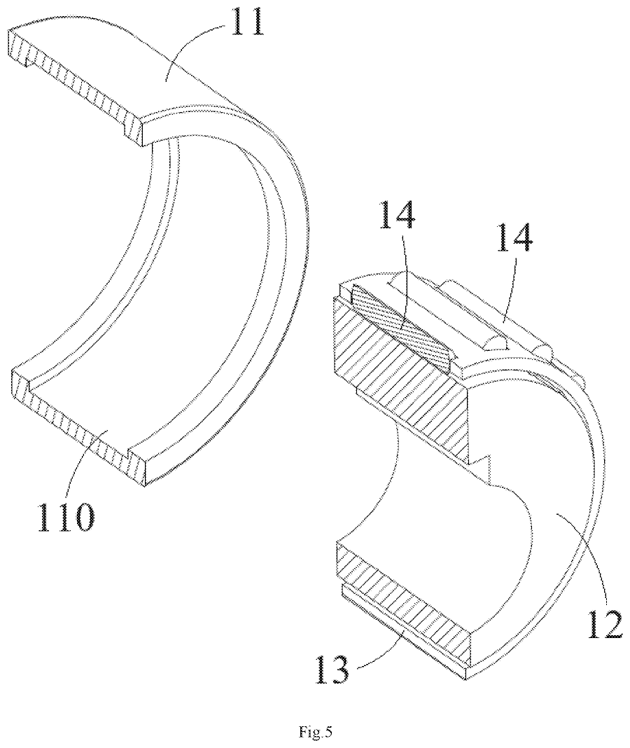

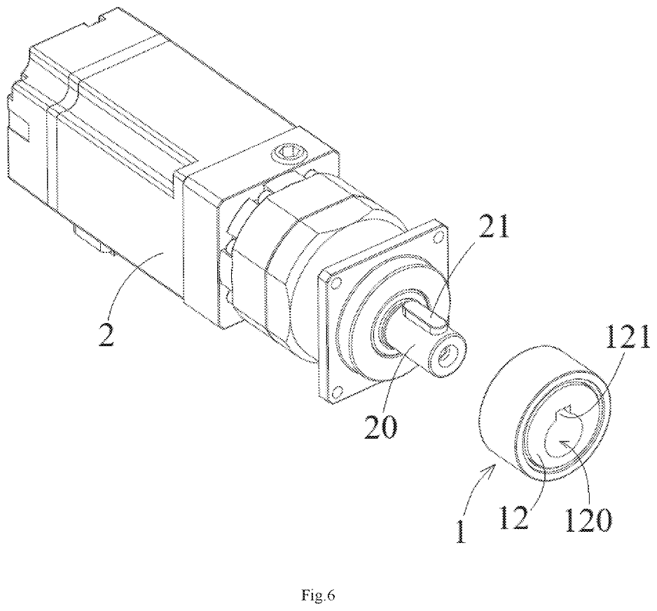

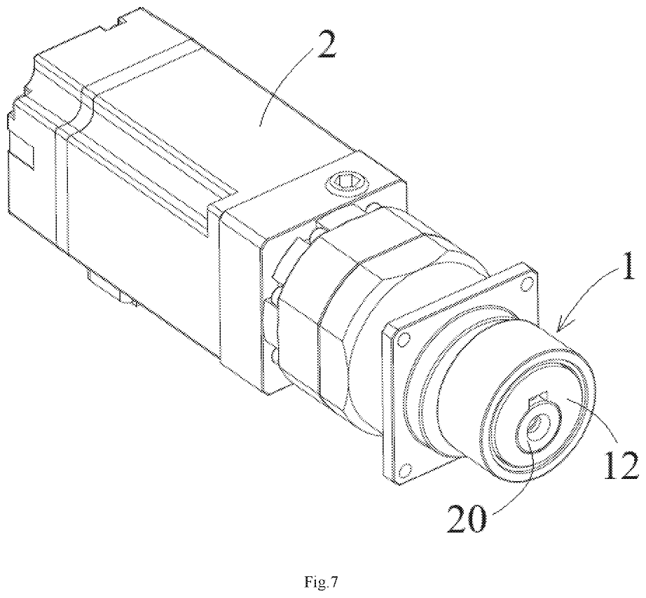

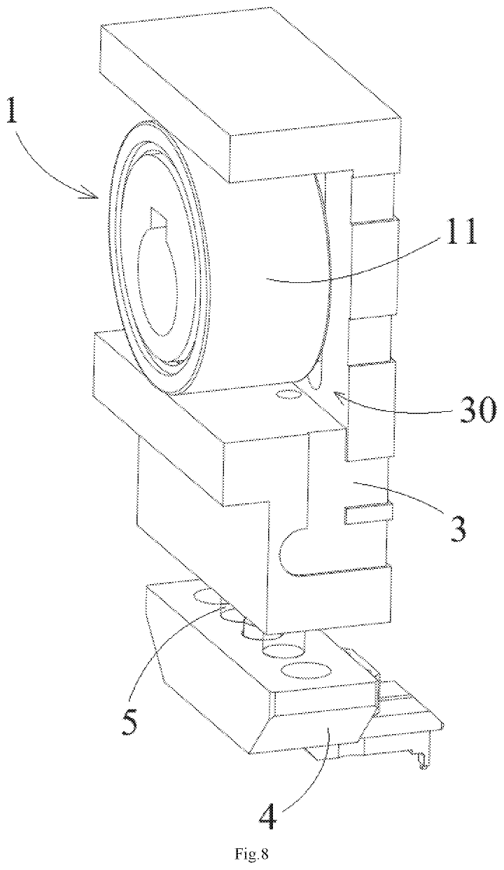

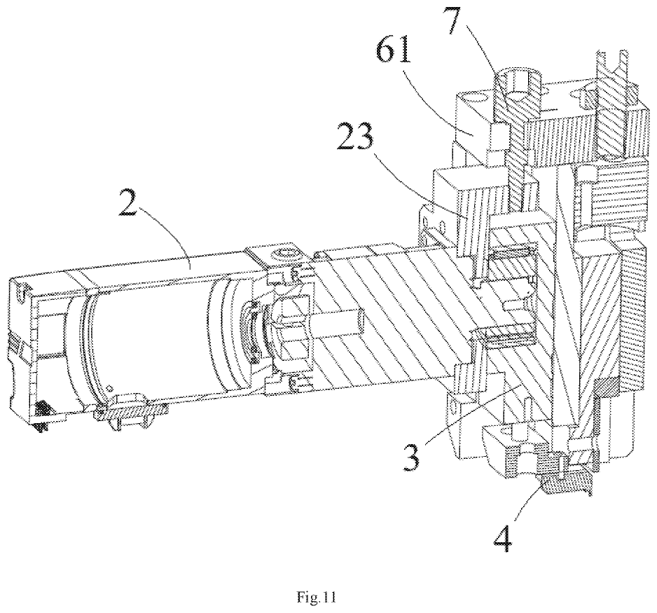

An exemplary embodiment of a transmission mechanism 1 will now be described with reference to FIGS. 1-11. As shown in FIGS. 1-2 and 4-5, the transmission mechanism 1 includes an outer sleeve 11 and an eccentric wheel 12. As shown in FIG. 8, the outer sleeve 11 is used to fix onto a movable block 3. The eccentric wheel 12 is rotatably installed in an interior surface 110 of the outer sleeve 11 and can be rotated relative to the outer sleeve 11. The eccentric wheel 12 has a mounting hole 120, as shown in FIGS. 2 and 6, suitable for mounting on a drive shaft 20, as shown in FIGS. 6-7. As shown in FIG. 1, a central axis X1 of the mounting hole 120 is parallel to a central axis X2 of the eccentric wheel 12 and spaced a predetermined distance d from the central axis X2 of the eccentric wheel 12, so that the transmission mechanism 1 can convert the rotational motion of the drive shaft 20 into linear reciprocating motion of the movable block 3.

As shown in FIGS. 2-5, the transmission mechanism 1 further includes multiple rollers 14. The multiple rollers 14 are arranged to roll between the outer sleeve 11 and the eccentric wheel 12 and are distributed at intervals in the circumferential direction of the outer sleeve 11. When the eccentric wheel 12 rotates relative to the outer sleeve 11, the rollers 14 comes into rolling contact with the eccentric wheel 12 and the outer sleeve 11 to reduce friction between the outer sleeve 11 and the eccentric wheel 12.

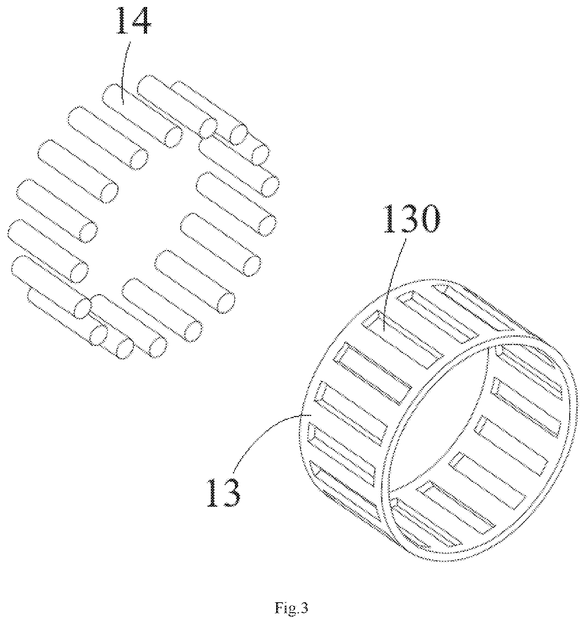

As shown in FIGS. 1-5, the transmission mechanism 1 further comprises a cylindrical cage 13. The cylindrical cage 13 is arranged between the outer sleeve 11 and the eccentric wheel 12 and has multiple limiting holes 130, as shown in FIG. 3, formed in its peripheral wall. The multiple rollers 14 are respectively rollably accommodated in the multiple limiting holes 130 of the cylindrical cage 13.

As shown in FIG. 3, the roller 14 is a cylindrical roller, and the limiting hole 130 is a strip-shaped hole. However, the present invention is not limited to the illustrated embodiments. For example, in another exemplary embodiment of the present invention, the roller 14 may be a spherical ball, and the limiting hole 130 may be a circular hole.

An exemplary embodiment of an electric drive device will now be described with reference to FIGS. 1-11. As shown in FIGS. 6-7, the electric drive device includes a servo motor 2 and the aforementioned transmission mechanism 1. The servo motor 2 has a drive shaft 20. As shown in FIG. 7, the drive shaft 20 is installed into the mounting hole 120 of the eccentric wheel 12 of the transmission mechanism 1, for driving the rotation of the eccentric wheel 12.

As shown in FIG. 6, a protruding key 21 is formed on the outer peripheral surface of the drive shaft 20, and a strip-shaped groove 121 is formed on the inner peripheral surface of the mounting hole 120 of the eccentric wheel 12. As shown in FIG. 7, the protruding key 21 is engaged with the strip-shaped groove 121 to position the eccentric wheel 12 in the circumferential direction.

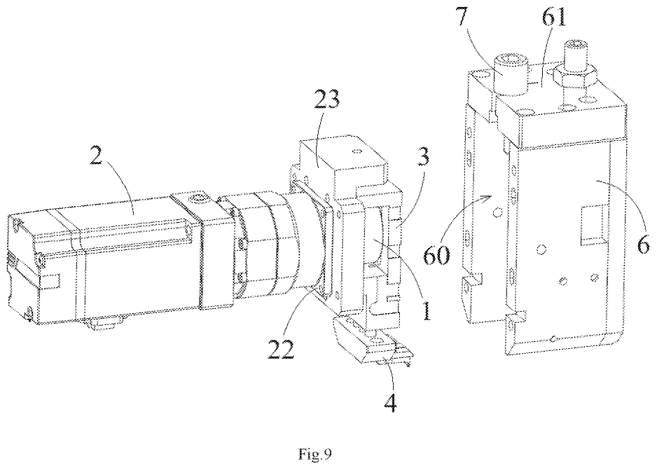

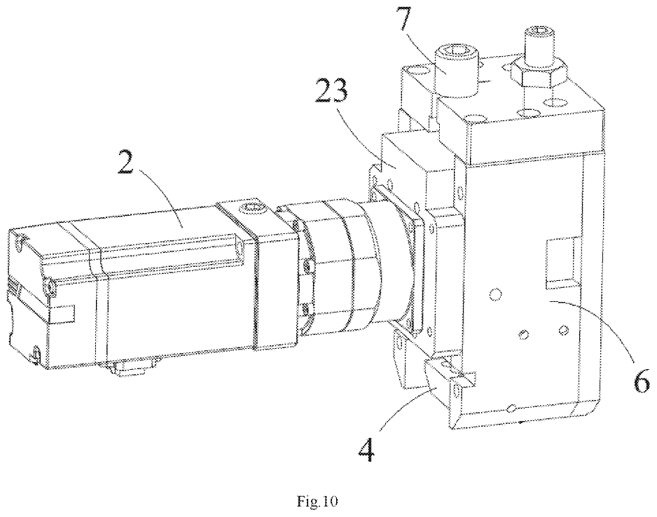

An exemplary embodiment of a terminal crimping device will now be described with reference to FIGS. 1-11. The terminal crimping device includes: a fixed block 6, as shown in FIGS. 9-10, a movable block 3, as shown in FIGS. 8-9 and 11, a crimping block 4, as shown in FIGS. 8-11, and the aforementioned electric drive device.

As shown in FIG. 9, the fixed block 6 is formed with a vertically extending guide groove 60. The movable block 3 is installed in the guide groove 60 in a movable manner and can be moved vertically along the guide groove 60. The crimping block 4 is installed at the bottom of the movable block 3 in a movable manner and can be moved vertically relative to the movable block 3. The servo motor 2 of the electric drive device is installed on the fixed block 6, and the outer sleeve 11 of the electric drive device is fixed to the movable block 3. The electric drive device is used to drive the movable block 3 to reciprocate in the vertical direction. The crimping block 4 is suitable for moving vertically under the drive of the movable block 3 to crimp a terminal onto an electrical connection member.

As shown in FIG. 8, the terminal crimping device further comprises an elastic component 5. The elastic component 5 is compressed between the movable block 3 and the crimping block 4. In the illustrated embodiment, the elastic component 5 may include multiple helical springs arranged side by side.

As shown in FIG. 8, an installation slot 30 is formed on the movable block 3. The outer sleeve 11 is fixedly installed in the installation slot 30 of the movable block 3.

As shown in FIGS. 9-11, the terminal crimping device further comprises a mounting plate 23. The mounting plate 23 is fixed to a flange 22 of the housing of the servo motor 2. The top of the mounting plate 23 is connected to a top wall 61 of the fixed block 6 to mount the servo motor 2 onto the fixed block 6.

As shown in FIGS. 9-11, the terminal crimping device further comprises an adjusting bolt 7. The adjusting bolt 7 passes through the top wall 61 of the fixed block 6 and is threaded with the top of the mounting plate 23 to connect the mounting plate 23 to the fixed block 6. The position of the mounting plate 23 relative to fixed block 6 in the vertical direction can be adjusted by rotating the adjusting bolt 7, so that the initial position of the crimping block 4 in the vertical direction can be adjusted by rotating the adjusting bolt 7.

The electrical connection member can be a flexible flat cable, a flexible circuit board, or a circular cable. The terminal crimping device is used to crimp the terminal onto the flexible flat cable, the flexible circuit board, or the circular cable.

In the aforementioned exemplary embodiments according to the present invention, the electric drive device composed of a servo motor 2 and an eccentric transmission mechanism 1 can greatly improve the terminal crimping speed. Compared with existing cylinder drive devices, the electric drive device of the present invention can increase the terminal crimping speed by several times, even tens of times. In addition, the electric drive device in the present invention also has the advantages of small size and low cost.

It should be appreciated for those skilled in this art that the above embodiments are intended to be illustrative, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

1. A transmission mechanism, comprising:
an outer sleeve fixed to a movable block; and
an eccentric wheel rotatably installed in the outer sleeve, the eccentric wheel is rotatable relative to the outer sleeve, the eccentric wheel has a mounting hole mountable on a drive shaft, a central axis of the mounting hole is parallel to, and at a predetermined distance from, a central axis of the eccentric wheel, such that the transmission mechanism can convert a rotational motion of the drive shaft into a linear reciprocating motion of the movable block.

2. The transmission mechanism of claim 1, further comprising a plurality of rollers arranged in a rolling manner between the outer sleeve and the eccentric wheel and distributed at intervals in a circumferential direction of the outer sleeve, when the eccentric wheel is rotated relative to the outer sleeve, the rollers come into rolling contact with the eccentric wheel and the outer sleeve to reduce friction between the outer sleeve and the eccentric wheel.

3. The transmission mechanism of claim 2, further comprising a cylindrical cage arranged between the outer sleeve and the eccentric wheel.

4. The transmission mechanism of claim 3, wherein the cylindrical cage has a plurality of limiting holes formed in its peripheral wall, each roller is rollably accommodated in one limiting hole.

5. The transmission mechanism of claim 4, wherein the roller is a cylindrical roller, and the limiting hole is a strip-shaped hole.

6. The transmission mechanism of claim 4, wherein the roller is a spherical ball, and the limiting hole is a circular hole.

7. An electric drive device, comprising:
a servo motor with a drive shaft; and
a transmission mechanism including an outer sleeve and an eccentric wheel, the outer sleeve is fixed to a movable block, the eccentric wheel is rotatably installed in the outer sleeve, the eccentric wheel is rotatable relative to the outer sleeve, the eccentric wheel has a mounting hole, the drive shaft is installed into the mounting hole for driving a rotation of the eccentric wheel, a central axis of the mounting hole is parallel to, and at a predetermined distance from, a central axis of the eccentric wheel, such that the transmission mechanism can convert a rotational motion of the drive shaft into a linear reciprocating motion of the movable block.

8. The electric drive device of claim 7, wherein a protruding key is formed on an outer peripheral surface of the drive shaft, and a strip-shaped groove is formed on an inner peripheral surface of the mounting hole of the eccentric wheel, the protruding key is engaged with the strip-shaped groove to position the eccentric wheel in a circumferential direction of the outer sleeve.

9. A terminal crimping device, comprising:
a fixed block formed with a vertically extending guide groove;
a movable block installed in the guide groove and movable along the guide groove;
a crimping block installed at a bottom of the movable block in a movable manner, and movable in a vertical direction relative to the movable block; and
an electric drive device including a servo motor and a transmission mechanism, the servo motor has a drive shaft, the transmission mechanism includes an outer sleeve and an eccentric wheel, the eccentric wheel is rotatably installed in the outer sleeve, the eccentric wheel is rotatable relative to the outer sleeve, the eccentric wheel has a mounting hole, the drive shaft is installed into the mounting hole for driving a rotation of the eccentric wheel, a central axis of the mounting hole is parallel to, and at a predetermined distance from, a central axis of the eccentric wheel, such that the transmission mechanism can convert a rotational motion of the drive shaft into a linear reciprocating motion of the movable block, the servo motor is installed on the fixed block, the outer sleeve is fixed to the movable block, the electric drive device drives the movable block to reciprocate in the vertical direction, the crimping block moves along the vertical direction under a drive of the movable block to crimp a terminal onto an electrical connection member.

10. The terminal crimping device of claim 9, further comprising an elastic component compressed between the movable block and the crimping block.

11. The terminal crimping device of claim 9, wherein an installation slot is formed on the movable block, the outer sleeve is fixedly installed in the installation slot.

12. The terminal crimping device of claim 11, further comprising a mounting plate fixed to a flange of a housing of the servo motor, a top of the mounting plate is connected to a top wall of the fixed block to mount the servo motor onto the fixed block.

13. The terminal crimping device of claim 12, further comprising an adjusting bolt passing through the top wall of the fixed block.

14. The terminal crimping device of claim 13, wherein the adjusting bolt is threaded with the top of the mounting plate to connect the mounting plate to the fixed block, a position of the mounting plate relative to the fixed block in the vertical direction is adjusted by rotating the adjusting bolt, such that an initial position of the crimping block in the vertical direction is adjusted by rotating the adjusting bolt.

15. The terminal crimping device of claim 9, wherein the electrical connection member is a flexible flat cable, a flexible circuit board, or a circular cable, the terminal crimping device crimps the terminal onto the flexible flat cable, the flexible circuit board, or the circular cable.

16. The terminal crimping device of claim 10, wherein the elastic component includes at least one helical spring.

17. The terminal crimping device of claim 10, wherein the elastic component includes a plurality of helical springs arranged side by side.
